(19) United States
(12) Patent Application Publication
(10) Pub. No.: US 2004/0200316 A1
(43) Pub. Date: Oct. 14, 2004

(54) Transmission assembly, especially for engines in walk-behind equipment and engines equipped with such a transmission assembly

(76) Inventor: Robert Blanchard, Le Boupere (FR)

Correspondence Address: YOUNG & THOMPSON, 745 SOUTH 23RD STREET 2ND FLOOR, ARLINGTON, VA, 22202

(21) Appl. No.: 10/680,263

(22) Filed: Oct. 8, 2003

(30) Foreign Application Priority Data
Oct. 9, 2002 (FR) 0212509

(51) Int. Cl. F16H 1/00

(52) U.S. Cl. 74/810.1

(57) ABSTRACT

The invention relates to a transmission assembly comprising at least one input shaft (1) driven in rotation and in engagement with a toothed wheel (2A).

This assembly is characterized in that it comprises at least two counter-rotating toothed wheels (2A, 2B), respectively in engagement with the input shaft (1), each wheel (2A, 2B) being coupleable to a shaft (3A, 3B) called a drive shaft in forward movement or respectively in rearward movement of the engine by means of a clutch device (4A, 4B), the clutch devices (4A, 4B) being selectively actuable as a function of the position taken by an angularly displaceable member (5, 7) of the clutch control device, the movement of each shaft (3A, 3B) carrying a clutch device (4A, 4B) being, in the active condition of its clutch device, transmitted to an output shaft (6).

The present invention relates to a transmission assembly, particularly for engines preferably of the walk-behind type, such as a snow blower or a mower, provided with such a transmission assembly.

It relates more particularly to a transmission assembly of the type comprising an input shaft, such as an endless screw, driven in rotation and in engagement with at least one toothed wheel, this wheel, mounted freely in rotation on a drive shaft of the engine being coupleable to said shaft by means of a clutch device adapted to pass from an engaged position to a disengaged position and vice versa, by means of a suitable control device, the movement of the shaft carrying the clutch device being transmitted directly or by means of an intermediate device, to an output shaft, such as the wheel carrying shaft of the engine.

Most of the transmissions on the market today, comprise a reversing device positioned on the output shaft.

As a result, it is necessary to carry out the movement reversing operation in the unclutched position of the transmission. This control maneuver of clutching and reversal is thus adapted to give rise to a breakage of the transmission.

An object of the present invention is thus to provide a transmission whose design permits avoiding any false manipulation as to clutching and reversal of the direction of movement of the engine.

Another object of the present invention is to provide a transmission whose design permits passing from forward movement to rearward movement of the engine or vice versa without the need to intervene in the manual clutching control by maintaining this latter in an engaged condition.

To this end, the invention has for an object a transmission assembly, particularly for engines preferably of the walk-behind type, said assembly comprising an input shaft, such as an endless screw, driven in rotation and in engagement with a toothed wheel, this wheel being mounted freely in rotation on a shaft called a drive shaft of the engine and coupleable to said shaft by means of a clutching device adapted to pass from an engaged position to a disengaged position and vice versa, by means of a suitable control device, the movement of the shaft carrying the clutching device being transmitted directly or by means of an intermediate device to an output shaft, such as the wheel carrying shaft of the engine, characterized in that said transmission assembly comprises at least two teethed wheels tangent to the input shaft, counter-rotating, respectively in engagement with the input shaft, each wheel being coupleable to the shaft called the drive shaft in forward movement or respectively in rearward movement of the engine by means of a clutch device adapted to pass from an engaged position to a disengaged position and vice versa, the clutching devices being selectively actuable as a function of the position taken by at least one member movable angularly of the clutch control device, the movement of each carrying shaft of a clutching device being, in the active condition of its clutching device, transmitted directly or by means of an intermediate device to an output shaft, such as the wheel carrying shaft of the engine.

According to a preferred embodiment of the invention, the control device is constituted on the one hand by a pivot which causes, in the course of its angular movement, directly or by means of an intermediate member, an actuation/de-actuation of the clutch control member or members, on the other hand by a so-called lever for reversing the direction of movement of the engine, mounted on said pivot, this lever being driven pivotably about an axle extending transversely to the axis of the pivot so as to be able to pass from a so-called forward movement position in which it extends from one side of said pivot, to a so-called rearward movement position in which it extends to the other side of said pivot and vice versa, by passing through a neutral position in which the lever prolongs the pivot, this lever being subject to the action of a control, such as a cable control, adapted to exert on said lever a tractive force causing, in the forward movement position of the lever, an angular movement of the pivot in a first direction and correspondingly the engagement of the drive shaft for forward movement of the engine, and in a rearward movement position of the lever, an angular movement of the pivot in an opposite direction, resulting in the engagement of the drive shaft for the rearward movement of the engine, said pivot being returned to a predetermined position corresponding to a disengaged position.

According to another preferred embodiment of the invention, the transmission comprises a clutch control member, such as a fork, common to the two clutchig devices.

The invention also has for its object an engine, preferably of the walk-behind type, such as a snow blower or a mower, this engine being provided with a transmission comprising an input shaft, such as an endless screw, driven in rotation and in engagement with a toothed wheel, this wheel being mounted freely in rotation on a so-called drive shaft for the engine and coupleable to said shaft by means of a clutching device adapted to pass from an engaged position to a disengaged position and vice versa by means of a suitable control device, the movement of the shaft carrying the clutch device being transmitted directly or by means of an intermediate device to an output shaft, such as the wheel carrying shaft of the engine, characterized in that the transmission and its control device are of the mentioned type.

The invention will be better understood from a reading of the following description of embodiments, with reference to the accompanying drawings, in which:

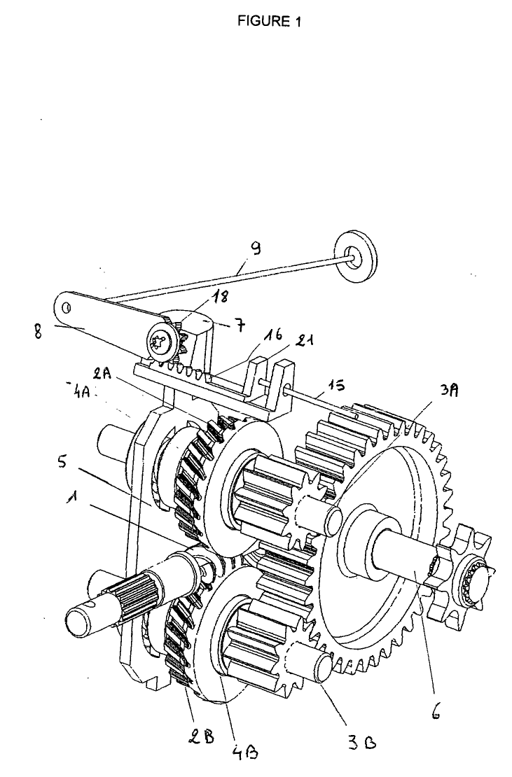

FIG. 1 is a schematic perspective view of a transmission assembly according to the invention;

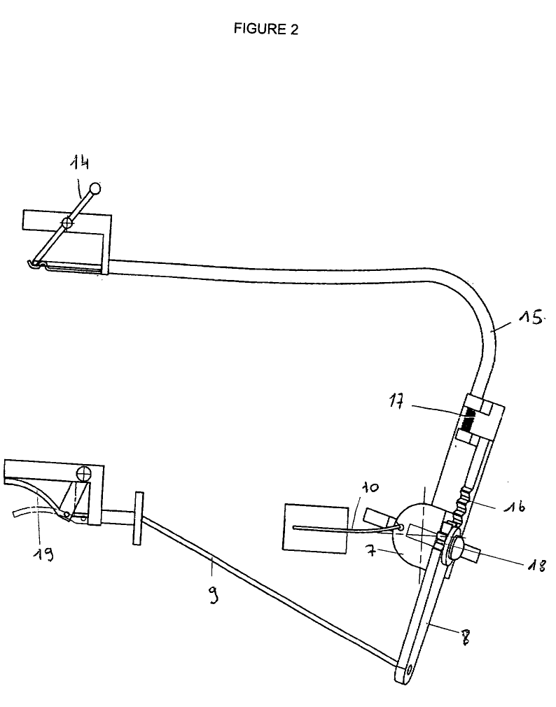

FIG. 2 is a schematic view of the control device of the transmission by manipulating members positioned adjacent the driving member of the engine, the control device being shown in the engaged position for forward movement of the engine;

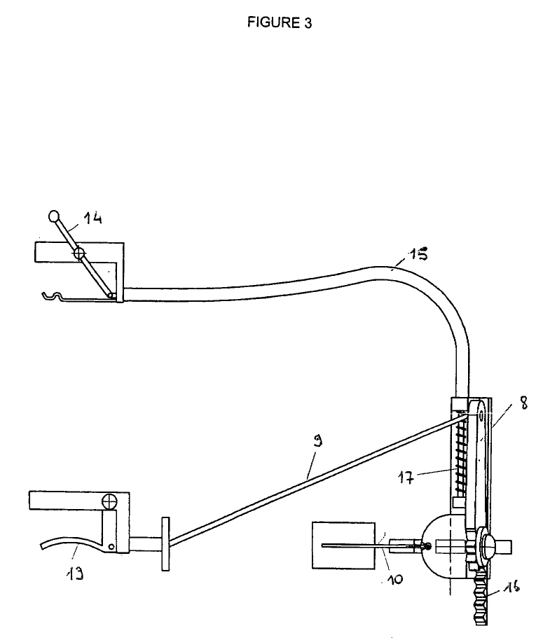

FIG. 3 is a schematic view from above of the control device of the transmission in the unclutched position for rearward movement of the engine;

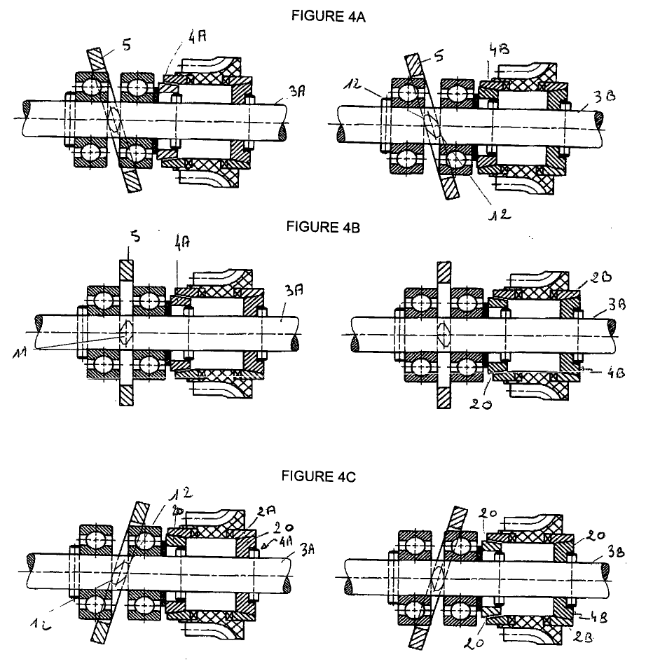

FIGS. 4A to 4C show, in the form of cross-sectional views, the different positions that can be taken by the fork in the devices, the left column showing the position taken by the fork on the drive shaft in forward movement of the engine, the right column showing the different positions taken by the fork on the drive shaft in rearward movement of the engine;

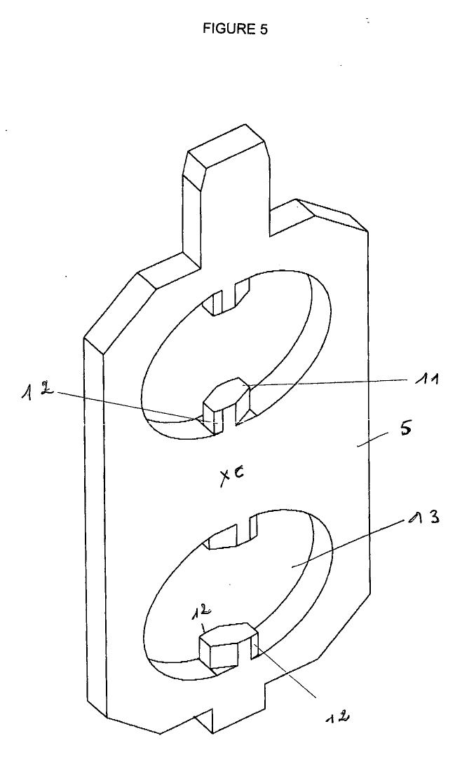

FIG. 5 is a perspective view of the fork;

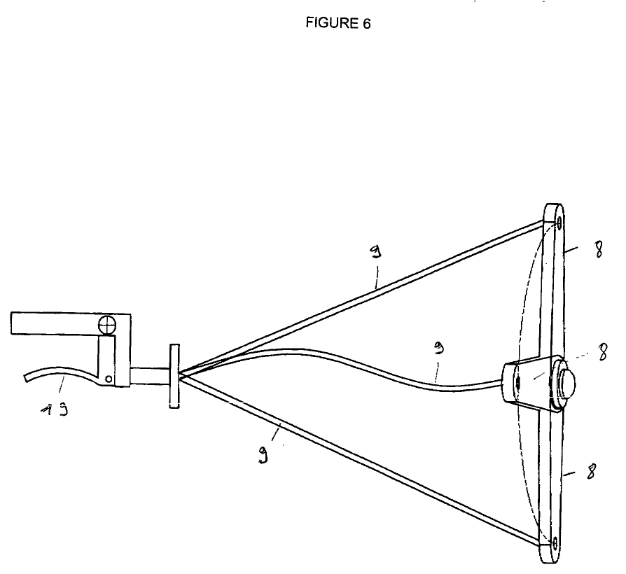

FIG. 6 is a schematic view from above of the lever in its different positions (forward movement or rearward movement, neutral position) in the absence of actuation of the clutch manipulating handle;

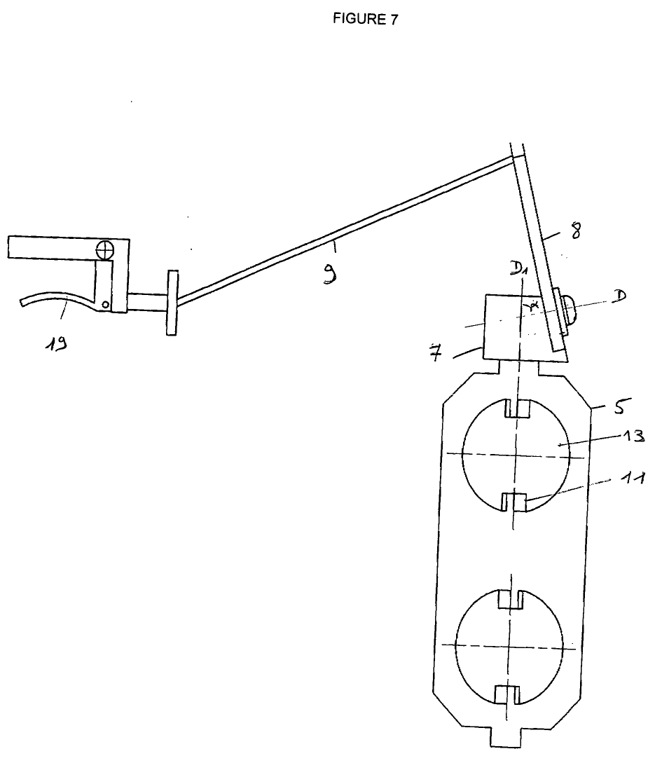

FIG. 7 is a side view of the control device of the transmission, and

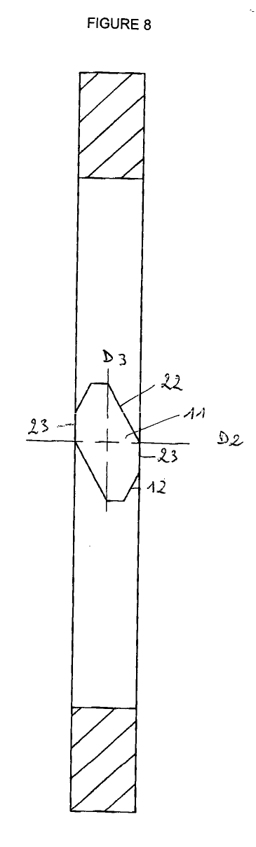

FIG. 8 is a schematic enlarged top plan view of the teeth of the fork.

As mentioned above, the transmission and assembly according to the invention is applicable more particularly to engines preferably of the walk-behind type, such as lawnmowers or snow blowers. Thus, small snow blowers have been developed in recent years and are generally constituted by a rolling chassis comprising at the front a cutter, this cutter being driven in rotation by the drive shaft of the engine. Such an engine also comprises a conduit for projecting snow, a blower being positioned between the cutter and the mouth of the projection conduit for snow to make the snow thus cut to be evacuated through said conduit. There can be considered to be a parallel between this type of engine and mowers in which the motor shaft drives in rotation the cutting blade of said engine.

This motor shaft driving a cutter blade or a cutter is coupled generally by a speed changer of the belt type to an input shaft 1, such as an endless screw, driven in rotation by means of the drive shaft of the engine. According to the invention, this input shaft 1 is in permanent engagement with two toothed wheels 2A, 2B tangent to the shaft 1. These two toothed wheels are disposed, in the illustrated embodiments, diametrically opposed on the endless screw so as to be driven in rotation in opposite directions. In this first embodiment of the invention, the two toothed wheels 2A, 2B come into engagement with a same screw thread on the endless screw 1. In another embodiment of the invention, the two toothed wheels each come into an engagement with a screw thread of the endless screw. This endless screw thus comprises two screw threads with reversed pitches to permit the drive in a counter-rotating manner of the two toothed wheels disposed tangentially to the endless screw. Each toothed wheel 2A, 2B is mounted freely in rotation on a shaft 3A, 3B and is coupleable with this shaft 3A, 3B by means of a clutch device 4A, 4B. Thus, the toothed wheel 2A is coupleable to the shaft 3A for driving the engine in forward movement, whilst the toothed wheel 2B is coupleable to the shaft 3B for driving the engine in a rearward direction. These shafts 3A and 3B are disposed substantially parallel. The coupling between the toothed wheel 2A and the shaft 3A for driving the engine with forward movement is effectuated by means of a first clutching device 4A, whilst the coupling between the toothed wheel 2B and the shaft 3B for driving the engine with rearward movement takes place by means of a clutching device 4B. In the illustrated embodiments, in particular in FIGS. 4A to 4C, the clutching device is a cone clutch 20. The passage from a clutched position to an unclutched position and vice versa, of each clutching device, takes place by means of a suitable control device which will be described hereafter. In the case of a cone clutching device, a member 5, such as a fork, of the control device, controls the spacing or respectively the approach of the cones such that the cone disposed within the toothed wheel comes into bearing against an internal conical periphery of said toothed wheel and ensures the clutching of the toothed wheel with the drive shaft. The cones thus constitute the driven elements of the clutching device, the toothed wheel constituting the driving element of this clutch device. Correspondingly, this clutch device could have been constituted by a dog clutch, the toothed wheel carrying the teeth coming into engagement with the teeth of a wing with frontal teeth, this ring being adapted to be brought toward or away from said toothed wheel by the control member 5. The movement of each shaft 3A, 3B carrying a clutch device 4A, 4B is thus, in the active condition of the clutch device which it carries, transmitted directly or by means of an intermediate device to an output shaft 6, such as the shaft carrying the wheels of the engine. In the illustrated examples, the transmission of the movement between the shafts carrying the clutching device and the output shaft 6 is effectuated by a system of pinions. In a manner characteristic of the invention, each clutching device 4A, 4B is selectively actuable by a control device consisting essentially of a pivot 7, a lever 8 and a control member 5. In the illustrated examples, the clutch control 5, constituted in this instance by a fork, is common to the two clutching devices 4A, 4B. This clutch control member is arranged to permit, as a function of its angular movement, the alternative control of one or the other of the clutching devices, this control member being returned to a predetermined position corresponding to a neutral unclutched position of the clutch devices. To permit the angular displacement of this control member 5 of the clutch device, in one direction or in the other direction as a function of the desired direction of movement of the engine, there is provided on the one hand a pivot 7 causing, in the course of its angular movement, directly or by means of an intermediate member, an actuation/inactuation of the clutch control member or members 5, on the other hand by a lever 8, called a lever for reversal of direction of the engine, mounted on said pivot 7. This lever 8 is driven pivotably about an axis extending transversely to the axis of the pivot 7 so as to be able to pass from a so-called forward movement position in which it extends to one side of side pivot 7, to a so-called rearward movement position in which it extends to the other side of said pivot 7 and vice versa, by passing through a neutral position in which the lever 8 prolongs the pivot 7. This lever 8 is subject to the action of a control 9, such as a control cable, adapted to exert on said lever 8 a tractive force giving rise, in the forward movement position of the lever 8, to an angular displacement of the pivot 7 in a first direction and correspondingly the clutching of the drive shaft 3A in the forward drive position of the engine, and in a rearward movement position of the lever 8, an angular displacement of the pivot 7 in an opposite direction and accordingly the clutching of the shaft 3B for driving the engine in a rearward direction. This pivot 7 is returned by a spring 10 into a predetermined position corresponding to an unclutched position, this position being shown in FIG. 4B. In the illustrated examples, the pivot 7 and the clutch control member 5, which move together, are mounted pivotably about a common axle and are directly connected to each other to constitute a monobloc assembly, which can be even monolithic. Thus, the fork is controlled directly in angular displacement by the pivot 7 which is for example constituted by a sleeve positioned directly at one end of the tubular body of the fork. This pivot assembly 7/fork 5 thus constitutes the angularly displaceable member of the control device whose position determines the selective actuation of one or the other of the clutch devices.

In an equivalent manner, it could be provided that the pivot 7 act by means of cams on two separate clutch control devices 5. This solution is however more complicated to employ. In this case, the pivot 7 constitutes the member for selecting the actuation of the clutching device.

As shown in the drawings, the lever 8 for reversing the direction is controlled in its pivotal movement by a maneuvering member 14, such as a pivoting lever, positionable adjacent the drive member for the engine, this manipulating member 14 being connected by a movement transmission, such as a control cable 15, to a rack 16 loaded by spring 17 and in engagement with a toothed portion 18 of the reversing lever 8. This rack 18 is guided in movement by means of a member 21, mounted securely on the pivot 7 or the fork 5. The cable control 9, subjecting the reversing lever 8 to a tractive force, is itself constituted at least by a cable connecting the lever 8 to a manipulating member, such as a pivotable handle 19, positionable adjacent the drive member of the engine. The driver must thus act on the one hand on the manipulating member 14 to control the forward or rearward movement of the engine, on the other hand on the manipulating member 19 to control the clutching in forward or respectively rearward movement of the engine.

In a preferred embodiment of the invention, the axis D for pivoting of the lever 8 and the axis D1 of the pivot 7 returned by spring 10 to a predetermined position, formed between then an angle α different from 90°, in particular less than 90°, and are oriented relative to each other to permit, in the clutched position obtained by exerting a predetermined tractive force on the control cable 9, the passage of the reversing lever 8 from one movement position to another without modifying the tractive force exerted on the cable 9. In the illustrated example, the angle α is about 80°. There thus results the possibility, for the driver, to maintain the manipulating member 19 in the clutched position, including during passage from a forward movement position to a rearward movement position of the manipulating member 14. Thus, because of this particular mounting of the reversing lever 8 on the pivot, it will be seen, as shown in particular in FIG. 6, that the reversing lever 8 gives rise, during passage of the lever 8 from one movement position to the other, to relaxation of the tension of the control cable 9 subject to a constant predetermined tractive force by means of the manipulating member 19. This relaxation of tension is compensated, in the engaged condition of the transmission, by a simultaneous angular movement of the pivot 7. Thus, if it is considered that the reversing lever 8 is positioned in the forward movement position and that a predetermined tractive force is exerted by means of the manipulating member 19 and of the cable 9 on said lever, to permit the passage from the engaged position of the clutching device, this position being according to that shown in FIG. 2, when the manipulating member 14 is actuated, it permits, by means of the cable 15 of the rack 16 and of the spring 17, the driving and pivotal movement of the reversing lever 8 to a neutral position and then its passage to rearward movement. In the course of its movement, the cable 9 tends progressively, for a constant force maintained on the manipulating member 19, to relax, this relaxation permitting an angular movement of the pivot 7 tending to bring this pivot 7 into a predetermined position corresponding to an unclutched position. As soon as the lever 8 has released the neutral position, in which position it is disposed in prolongation of the pivot 7, it tends, by means of the cable 9, to drive again this pivot 7 by pivoting in an opposite direction to generate the control of the clutching device of the drive shaft in rearward movement of the engine. It is thus possible to pass from a forward movement position to a rearward movement position and vice versa, without the driver having to modify the force exerted on the manipulating member 19 of the clutch control.

In this embodiment, the pivot 7 has the form of a tubular body having, along one of its generatrices, an inclined surface traversed by the pivotal axis of the reversing lever 8 and along which moves, in bearing contact, the lever 8 during passage from one movement position to the other. In the case in which the axis of pivoting of the lever 8 extends perpendicular to the axis of pivoting of the pivot 7, it is necessary inversely for the driver to relax the manipulating member 17 to pass from one movement position to another movement position of the lever 8. Such solution is thus less efficient.

The operation of such a control device is as follows. Starting from a neutral position corresponding to a position according to that shown in FIG. 6 when the lever is disposed in prolongation of the pivot 7 and in the absence of the exercise of traction on the cable 9, the driver can act on the manipulating member 14 to drive the lever 8 to move from one side or the other of the pivot as a function of the desired direction of movement of the engine. If the lever 8 is brought to a position as shown in FIG. 2 and traction is exerted on the cable 9 by means of the member 19, clutch control member 5 passes from a position shown in FIG. 4B, left column, to a position shown in FIG. 4C, left column, and ensures the clutching of the clutch device carried by the drive shaft 3A for forward movement of the engine. In parallel, the control member 5 moves in a manner similar to the drive shaft 3B in rearward movement of the engine. However, this control member is made such that it does not generate, in this position, any displacement of the driven elements, in this instance of the cone of the clutch device on the shaft 3B. As a result, only the drive shaft 3A of the engine in forward movement is in the engaged position. Conversely, when the lever 8 is brought to a position on the other side of pivot 7, the clutch control member 5 occupies the positions shown in FIG. 4A. There results a clutching of the clutch device positioned on the drive shaft 3B in rearward movement of the engine, whilst the clutch device 4A, positioned on the shaft 3A of the engine, remains in an unclutched position. To obtain such an operation, the clutch control member 5 has the shape of a fork kinematically secured for angular displacement to the pivot 7. This fork comprises two sets of teeth 11 each coacting, as a function of the angular position taken by the fork, with a clutch device 4A, 4B to permit the passage of the clutch device 4A, 4B from an unclutched position to a clutched position, and vice versa, these sets of teeth 11 being shaped to act in an asynchronous manner on the corresponding clutch device. Thus, as shown in FIGS. 4A to 4C, during angular movement of the pivot in one direction, the teeth of a set of teeth cause the clutching of a clutch device whilst the other set of teeth remains inactive on the clutch device carried by the other shaft. These sets of teeth are thus alternatively active to give rise to the passage from a clutched position to an unclutched position of the clutch device. Moreover, these sets of teeth are, in the neutral position of the reversing lever 8, disposed such that, relative to the clutch devices, they maintain the two clutch devices in inactive position. To permit such an operation, each set of teeth 11 is constituted by two polygonal teeth disposed diametrically opposed in a circular recess 13 of the fork body. Each tooth comprises two active parallel surfaces 12 disposed on opposite sides of the median diametral plane of the recess 13 and offset on said circle constituting the recess 13. These active surfaces 12 act by bearing in the manner of a spacer between a driven element, such as a cone, of the clutch device, and an abutment member, such as a roller, carried by the shaft 3A, 3B carrying the clutch device 4A, 4B and axially immobilized on this latter. The active surfaces 12 of a set of teeth relative to another set of teeth are disposed in a symmetrical manner relative to the median diametral plane of the recesses 13. In other words, the teeth of one recess 13 correspond to the teeth of the other recess 13 after rotation by 180° of the body of the fork about a center C shown in FIG. 5. It will thus be seen from FIG. 5 that the two circular recesses are positioned coplanar in the body of the fork and disposed one above the other, the diametrically opposed teeth being aligned on the pivotal drive axis of this fork. The center C is thus positioned on this pivotal axis equidistantly from the teeth of each of the recesses 13. These teeth thus have substantially the shape of a parallelogram as shown in FIG. 8, the active surfaces 12 of the teeth being constituted by the surfaces of the small sides of said parallelogram. These surfaces form, with the median diametral plane of the recess, an angle corresponding to the angular movement of the fork necessary to ensure clutching of the clutch device and bringing into bearing these surfaces in particular against the driven element of the clutch device. Conversely, the inactive surfaces 22 of the teeth formed by the large sides of the parallelogram constitute disengagement surfaces not adapted to exert any force against the clutch device. The edges of this parallelogram are truncated so as to form a flat 23 extending parallel to the median diametral plane of the recess 13. The connecting edge between flat 23 and active surface 12 is spaced from the median horizontal axis D2 of the recess, perpendicular to the axis D3 of rotation of the fork 5 to form a lever arm and to space the cone of the clutch device from the abutment member such as a roller carried by the carrying shaft of the clutch device. This flat 23 is thus spaced from the external surface of the fork 5.

Thanks to such a transmission assembly, the driver can thus as desired control in a first instance the direction of movement of the engine and then, in a second instance, the clutching of said engine, or, conversely, control the clutching of the engine and then pass from one direction of movement to another. There is thus no preferred control in such a transmission, such that any risk of breaking of the transmission is avoided.

1. Transmission assembly, particularly for an engine preferably of the walk-behind type, said assembly comprising an input shaft (1) such as an endless screw, driven in rotation and in engagement with a toothed wheel (2A), this wheel being mounted freely in rotation on a shaft (3A) called a drive shaft of the engine and coupleable to said shaft by means of a clutch device (4A) adapted to pass from a clutched position to an unclutched position and vice versa, by means of a suitable control device, the movement of the shaft (3A) carrying the clutch device (4A) being transmitted directly or by means of an intermediate device to an output shaft (6), such as the wheel carrying shaft of the engine, characterized in that said transmission assembly comprises at least two toothed wheels (2A, 2B) tangent to the input shaft (1), counter-rotating, respectively in engagement with the input shaft (1), each wheel (2A, 2B) being coupleable to a shaft (3A, 3B) called a drive shaft for forward movement or respectively for rearward movement of the engine by means of a clutch device (4A, 4B) adapted to pass from a clutched position to an unclutched position and vice versa, the clutch devices (4A, 4B) being selectively actuable as a function of the position taken by at least one angularly displaceable member (5, 7) of the clutch control device, the movement of each shaft (3A, 3B) carrying a clutch device (4A, 4B) being, in the active condition of its clutch device, transmitted directly or by means of an intermediate device to an output shaft (6) such as the wheel carrying shaft of the engine.

2. Transmission assembly according to claim 1,
characterized in that the control device is constituted on the one hand by a pivot (7) causing, in the course of its angular movement, directly or by means of an intermediate member, an actuation/de-actuation of the clutch control member or members (5), on the other hand by a lever (8), called a lever for reversing the direction of the engine, mounted on said pivot (7), this lever (8) being driven pivotably about an axis extending transversely to the axis of the pivot (7) so as to be able to pass from a position, called a forward movement position in which it extends to one side of said pivot (7), to a so-called rearward movement position in which it extends on the other side of said pivot (7) and vice versa, by passing through a neutral position in which the lever (8) prolongs the pivot (7), this lever (8) being subjected to the action of a control (9), such as a cable control, adapted to exert on said lever (8) a traction force which causes, in the forward movement position of the lever (8), an angular movement of the pivot (7) in a first direction and as a result the clutching of the drive shaft (3A) in the forward direction of the engine, and in a rearward direction of movement of the lever (8), an angular movement of the pivot (7) in an opposite direction and as a result the clutching of the drive shaft (3B) in the rearward movement direction of the engine, said pivot (7) being returned to a predetermined position corresponding to an unclutched position.

3. Transmission assembly according to claim 2,
characterized in that the axis (D) of pivoting of the lever (8) and the axis (D1) of the pivot (7) returned by a spring (10) to a predetermined position, form between them an angle α different from 90°, in particular less than 90° and oriented relative to each other to permit, in the clutched position obtained by exerting a predetermined tractive force on the control cable (9), the passage of the reversing lever (8) from one position of movement to another without modifying the tractive force exerted on the cable (9).

4. Transmission assembly according to claim 2,
characterized in that the reversing lever (8) is mounted on the pivot (7) so as to cause, during passage of the lever (8) from one position of movement to the other, a relaxation of the tension in the control cable (9) subject to a predetermined constant tractive force by means of a suitable manipulating member (19), this relaxation of the tension being compensated, in the engaged condition of the transmission, by a simultaneous angular movement of the pivot (7).

5. Transmission assembly according to claim 2,
characterized in that the pivot (7) has the form of a tubular body having, alone one of its generatrices, an inclined surface traversed by the pivotal axis of the reversing lever (8) and along which moves, in bearing contact, the lever (8) during passage from one movement position to another.

6. Transmission assembly according to claim 2,
characterized in that the transmission comprises a clutch control member (5), such as a fork, common to the two clutch devices (4A, 4B).

7. Transmission assembly according to claim 2,
characterized in that the pivot (7) and the clutch control member (5), kinematically secured together for movement, are mounted pivotably about a common axis and are directly connected to each other to constitute a monobloc assembly.

8. Transmission assembly according to claim 2,
characterized in that the clutch control member (5) has the form of a fork kinematically secured in angular movement to the pivot (7), this fork comprising two sets of teeth (11) each coacting, as a function of the angular position taken by the fork, with a clutch device (4A, 4B) to permit passage of the clutch device (4A, 4B) from an unclutched position to a clutched position and vice versa, these sets of teeth (11) being shaped to act asynchronously on the corresponding clutch device.

9. Transmission assembly according to claim 8,
characterized in that each set of teeth (11) is constituted by two polygonal teeth disposed diametrically opposed in a circular recess (13) of the fork body, each tooth comprising two active parallel surfaces (12) disposed on opposite sides of the median diametral plane of the recess (13) and offset on said circle constituting the recess (13), these active surfaces (12) acting by bearing in the manner of a spacer between a driven element of the clutch device and an abutment member carried by the shaft (3A, 3B) carrying the clutch device (4A, 4B), the active surfaces (12) from one set of teeth to another set of teeth being disposed symmetrically relative to a median diametral plane of the recesses (13).

10. Transmission assembly according to claim 8,
characterized in that the lever (8) for reversing movement is controlled in pivotal displacement by a manipulating member (14) such as a pivoting lever, positionable adjacent the drive member of the engine, this manipulating member (14) being connected by a movement transmission such as a control cable (15), to a rack (16) loaded by a spring (17) and engaging with a toothed portion (18) of the reversing lever (8).

11. Transmission assembly according to claim 2,
characterized in that the cable control (9), subjecting the reversing lever (8) to a tractive force, is constituted by at least one cable connecting the lever (8) to a manipulating member, such as a pivoting handle (19) positionable adjacent the drive member of the engine.

12. Engine, preferably of the walk-behind type, such as a snow blower or mower, this engine being provided with a transmission comprising an input shaft (1) such as an endless screw, driven in rotation and in engagement with a toothed wheel (2A), this wheel being freely mounted in rotation on a shaft (3A) called a drive shaft of the engine and coupleable to said shaft by means of a clutch device (4A) adapted to pass from a clutched position to an unclutched position and vice versa by means of a suitable control device, the movement of the shaft (3A) carrying the clutch device (4A) being transmitted directly or by means of an intermediate device to an output shaft (6), such as the shaft carrying the wheels of the engine,
characterized in that the transmission is according to claim 1.
